(19) United States
(12) Patent Application Publication
(10) Pub. No.: US 2007/0058234 A1
(43) Pub. Date: Mar. 15, 2007

(54) Method and apparatus for maintaining a constant image amplitude in a resonant mirror system

(75) Inventors: Eric Gregory Oettinger, Rochester, MN (US); Robert Edward Jansen, Rochester, MN (US); Arthur Monroe Turner, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/226,549

(22) Filed: Sep. 14, 2005

(51) Int. Cl. G02B 26/08

(52) U.S. Cl. 359/213; 359/900

(57) ABSTRACT

A method for maintaining the amplitude of oscillations of a mirror system comprising a high-Q resonant mirror driven by a high speed drive signal. Sensors monitor the sweep amplitude of the high-Q resonant mirror and a parameter of the drive signal is adjusted to maintain the sweep amplitude of the mirror at a constant value. According to one embodiment, the frequency of the drive signal is adjusted to more closely track the resonant frequency of the mirror, and according to another embodiment, the amplitude of the drive signal is increased to increase the amplitude of the sweep motion of the mirror. According to a third embodiment, the sweep amplitude may be maintained by adjusting both the drive signal amplitude and the drive signal frequency.

### TECHNICAL FIELD

The present invention relates to laser printers and video display systems comprising a resonant high speed scanning mirror for generating scan lines to produce a printed page or an image on a display. In addition for video display systems, there is also included a low frequency mirror operating substantial orthogonal to the high speed mirror for positioning each of the scan lines. More particularly, the present invention relates to maintaining a constant image amplitude even when the resonant frequency of the high speed scanning mirror varies from the nominal or central frequency.

### BACKGROUND

In recent years torsional hinged high frequency mirrors (and especially resonant high frequency mirrors) have made significant inroads as a replacement for spinning polygon mirrors as the drive engine for laser printers. These torsional hinged high speed resonant mirrors are less expensive and typically require less energy or drive power than the earlier polygon mirrors.

As a result of the observed advantages of using the torsional hinged mirrors in high speed printers, interest has developed concerning the possibility of also using a similar mirror system or arrangement for video displays that are generated by visible scan lines on a display surface in a manner somewhat similar to scan lines produced by the electron beam of a CRT (cathode ray tube) type TV.

CRT's and some mirror based systems for displaying such scan-line signals use a low frequency positioning circuit or mirror, which synchronizes the display frame rate with an incoming video signal, and a high frequency drive circuit or mirror, which generates the individual image lines (scan lines) of the video or printed page. In the prior art CRT type TV systems, the high speed circuit operates at a frequency that is an even multiple of the frequency of the low speed drive and this relationship simplifies the task of synchronization. Therefore, it would appear that a very simple corresponding torsional hinged mirror system could use a first high speed scanning mirror to generate scan lines and a second slower torsional hinged mirror to provide the orthogonal motion necessary to position or space the scan lines to produce a raster “scan” similar to the raster scan of the electron beam of a CRT. Unfortunately, the problem is more complex than that. The scanning motion of a high speed resonant scanning mirror cannot simply be selected to have a precise predetermined frequency, much less a predetermined frequency that is an even multiple of the positioning motion of the low frequency mirror.

More specifically, the positioning motion of the low speed mirror and consequently the low frequency drive signal must be tied to the incoming image frame rate of the video signals to avoid noticeable artifacts. For example, tying the drive signal to the incoming image frame rate of a video display avoids jumps or jitter in the display. At the same time, however, the high frequency mirror must run or oscillate at substantially its resonant frequency if the advantages of using a resonant mirror are to be realized. This is because driving a high-Q (quality factor) mirror at a frequency only slightly different than the resonant frequency will result in a significant decrease in the amplitude of the beam sweep (i.e. reduce the beam travel envelope). This amplitude decrease would cause a significant and unacceptable compression of the image on the printed page or display and change the aspect ratio of the final image. Therefore, the high speed mirror drive is decoupled from the low speed mirror drive. That is, as mentioned above, the high speed resonant mirror must oscillate substantially at its resonant frequency regardless of the frequency or movement of the slow speed mirror.

Also, as will also be appreciated by those skilled in the art, if the torsional hinges of a resonant torsional hinged device are subjected to compressive or tensional stress, the resonant frequency of the mirror will decrease or increase respectively. This is because the torsional hinged device is typically made of a material that has a very low TCE (Thermal Coefficient of Expansion), such as for example silicon, and the support structure is likely to be made of a metal such as aluminum or steel, which has a higher TCE. As a result of the differences in the two TCE temperature changes during the operation of the torsional hinged device often causes mechanical stress, which results in changes in the resonant frequency of the device.

Therefore, a mirror based video system that overcomes the above mentioned problems would be advantageous.

### SUMMARY OF THE INVENTION

These and other problems are generally solved or circumvented, and technical advantages are generally achieved by the embodiments of the present invention, which provide a method of maintaining a constant image width of a printer or mirror display system using a high speed, high-Q resonant scanning mirror. More specifically, the method comprises the step of providing a high frequency drive signal (such as for example a sinusoidal drive signal) for driving the high-Q resonant mirror. Sensors are provided to monitor the sweep amplitude of the resonant mirror, and then a parameter of the high frequency drive signal is adjusted to maintain the amplitude of the high-Q resonant mirror at a constant level.

According to one embodiment of the invention, the amplitude or drive power of the drive signal is increased as necessary to increase the sweep amplitude of the resonant mirror.

According to another embodiment, the frequency of the drive signal is continually adjusted to always be the same or substantially the same as the resonant frequency of the mirror, even when the resonant frequency of the scanning mirror changes due to mechanical or thermal stress. This is accomplished by temporarily changing the frequency of the drive signal by a selected amount in a first direction (i.e. either increase or decrease the frequency). The sweep amplitude of the mirror is then monitored to determine if the frequency change results in an amplitude increase or an amplitude decrease. If the amplitude of the mirror increases, the nominal or central frequency of the drive signal is reset to the adjusted frequency. Then on the next cycle, the frequency will again be adjusted in the same direction and again the sweep amplitude monitored to see if the amplitude decreases or increases. If the amplitude again increases, the nominal or central frequency of the drive signal is again reset. This continues until the sweep amplitude decreases when the frequency is adjusted. When the amplitude decreases, the frequency of the drive signal is again adjusted by the selected small amount, but this time the adjustment is in the opposite direction. The sweep amplitude is again monitored to determine if the amplitude increases or decreases as discussed above. Then, depending on whether the amplitude increases or decreases, the appropriate action follows as discussed above.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIGS. 1A and 1B illustrate, respectively, low speed (scan line positioning) and high speed (resonant scanning) cyclic signals for driving the mirrors of a display system about their axis;

FIG. 1C illustrates the high speed mirror sweep having reduced amplitude due to being driven at a frequency slightly off of the resonant frequency;

FIG. 1D is the same as FIG. 1A, except a triangular low speed drive signal is illustrated rather than a sinusoidal drive signal;

FIG. 2A illustrates an image frame generated by a torsional hinged mirror operating at resonant frequency and at full sweep amplitude;

FIG. 2B illustrates a distorted image frame similar to that of FIG. 2A, except the resonant mirror is operated off of resonance and at less than full sweep amplitude;

FIG. 3A is a simplified diagram illustrating a first embodiment of a torsional hinged mirror based display system using two single axis mirrors, wherein the high speed mirror reflects light towards the low speed mirror;

FIG. 3B is a second embodiment similar to FIG. 3A, except that the low speed mirror reflects light toward the high speed mirror;

FIG. 3C is a simplified diagram illustrating another embodiment comprising a single dual axis mirror in place of the two single axis mirrors; and

FIG. 4 is a prior art figure showing displays of video frame high frequency where the scan mirror operates at an even multiple of the low frequency positioning mirror.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

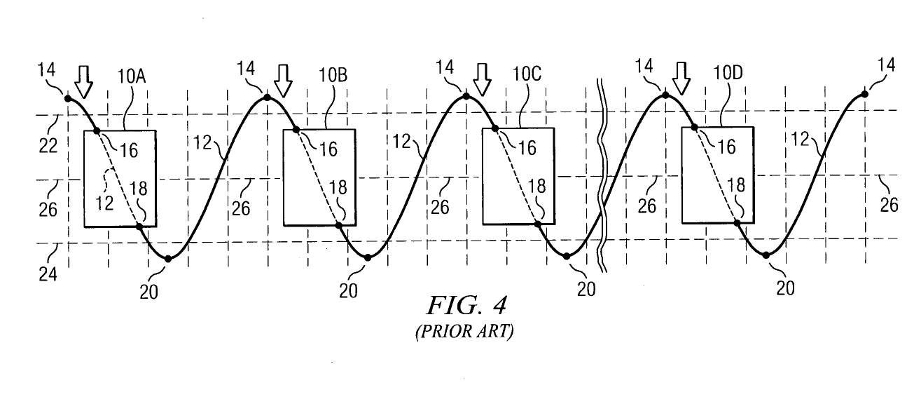

Referring now to the prior art FIG. 4, there is illustrated the interaction of a high speed horizontal scanning drive signal (scan lines) and a low speed (vertical) or scan line positioning signal. The terms “horizontal”, used with respect to scanning drive signals, and “vertical”, used with respect to the beam positioning signals, are for convenience and explanation purposes only, and it will be appreciated by those skilled in the art that the scan lines could run vertical and the positioning signals could position the vertical scan lines horizontally across a display screen.

As shown in the prior art FIG. 4, four typical frames of video such as indicated by image boxes 10a, 10b, 10c, and 10d are generated during the same (substantially linear) portion of each cycle of the slow speed sinusoidal drive signal represented by curve 12. The image boxes 10a through 10d in FIG. 4 on curve 12 represent the period of time the horizontal scan lines are turned on to produce an image. More specifically, if the slow speed positioning signal has a frequency of 60 Hz, then in the example of FIG. 4, sixty different frames of video (i.e. complete images), rather than the four as illustrated, will be generated in one second. Therefore, as shown in the figure, and assuming proper synchronization, each successive video frame will start and be located at the same position on a display screen. For example, if transition point 14 represents both the end point of each cycle of the positioning slow speed drive signal and the start point of the next cycle of the drive signal, then a point 16 can be selected to always occur a certain timer period thereafter. This point 16 can, therefore, also be selected as the start point (or placement of the first image pixel) of each frame. Likewise point 18 will be the end point (or placement of the last pixel) of each frame. In the prior art example of FIG. 4, the portion of the drive signal between points 16 and 18 is substantially linear and is referred to hereinafter as the display portion of the slow speed drive signal, whereas the transition point 14 and the reverse point 20 not only are not located during a linear portion of the signal, but as mentioned represent where the positioning drive signal actually stops and reverses the direction of the electron beam or mirror. These reverse or “turn-around” portions (above line 22 and below line 24) of the drive signal are referred to hereinafter as the upper and lower peak portions or transition points of the drive signal.

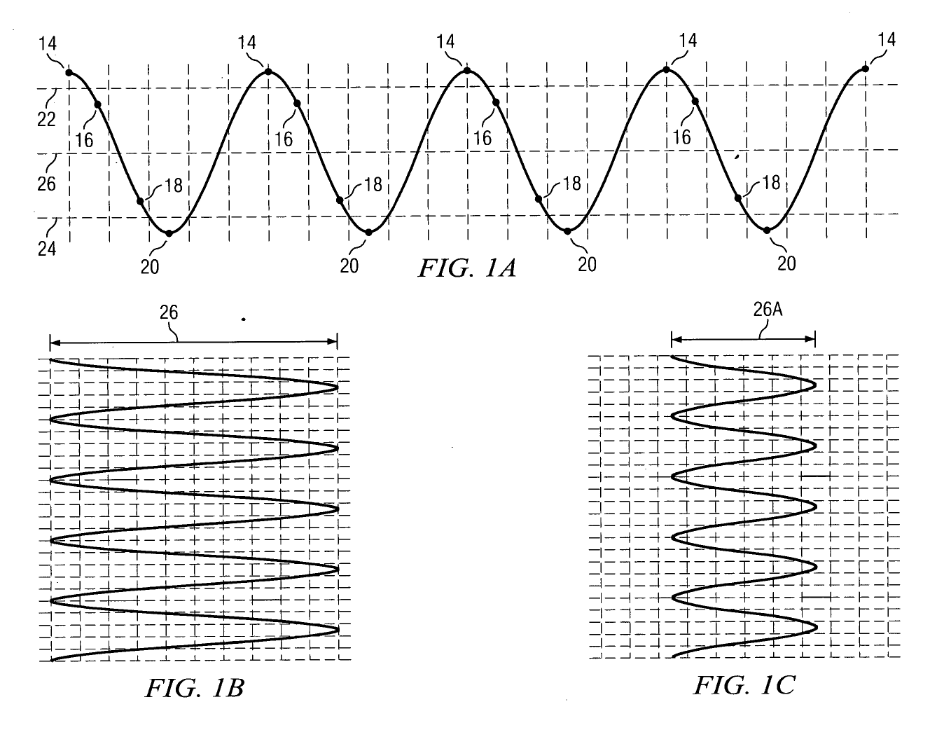

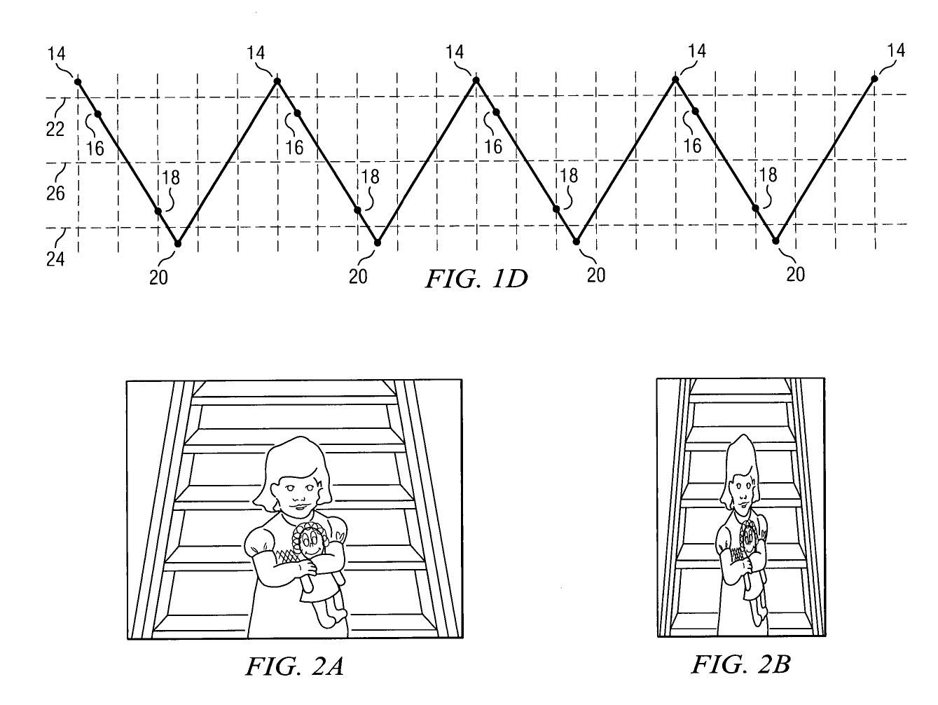

FIG. 1A is similar to FIG. 4 and represents the mirror position or slow speed mirror drive signal for moving the slow speed (vertical) mirror, but does not include representations of a printed page or the frames of video display 10a through 10d. FIG. 1B represents the high speed or scanning drive signal and/or the corresponding scanning position of a resonant mirror according to the teachings of the present invention, but is not to scale with respect to FIG. 1A. As an example, whereas the slow speed or positioning mirror may oscillate at a frequency of about 60 Hz, the resonant frequency of a scanning torsional hinged mirror, such as illustrated in FIG. 1B, may be on the order of 20 kHz or even greater. It would of course be less than 20 kHz.

FIG. 1D is similar to FIG. 1A, and illustrates that the slow speed cyclic drive signal may have a different waveform, including a repetitive triangular shape, rather than a sinusoidal shape. The portion of the curve 12 above and below lines 22 and 24 respectively still represent the upper and lower peak (or turn-around) portions of the mirror movement, and the portion of the curve between lines 22 and 24 still represent the display portion of the signal and/or mirror movement where the video frame is generated.

Further, as will be appreciated by those skilled in the art, driving a resonant mirror at a speed only slightly off of its resonant speed can drastically reduce the sweep amplitude of the mirror, which in turn can significantly change or distort the display or printed page. For example, if FIG. 1B represents the amplitude of the beam sweep of the high speed resonant mirror as it operates at its resonant frequency, FIG. 2A represents an image frame on a display generated by the mirror having the proper sweep amplitude (represented by double headed arrow 26 in FIG. 1B) and aspect ratio. However, the doubled headed arrow 26a of FIG. 1C represents the significant reduction in sweep amplitude that results when a resonant mirror is driven at a frequency that is only slightly different than the resonant frequency of the mirror. FIG. 2B illustrates the effect of such an amplitude difference on the aspect ratio of a display and the corresponding distortion of the image.

The present invention solves these problems by providing methods and apparatus for maintaining a constant sweep amplitude of the high speed resonant mirror.

It is also important to note that for some applications or embodiments, it may be possible that the required steps or calibration adjustment for maintaining the sweep amplitude of the high speed mirror can be accomplished during the upper peak portions of the drive signal (the portion above line 22), while the signal is blanked or cut off. It would also be possible, or course, that similar and effective adjustments could be made in the lower peak portion (i.e. portions below line 24). Alternately, a portion of the adjustment could take place in the upper peak portions and another portion in the lower peak portions. When possible, carrying out the adjustments during the upper and/or lower peak portions would be an excellent choice. Unfortunately, because of the very high-Q and the high speed of the resonant mirror, the time available during the upper (or lower) peak portions, for many if not for most applications, would be insufficient to complete the calibrations. Therefore, according to another embodiment, the calibration process is continuous. That is, it occurs during the display portions as well as the upper and lower peak portions of the movement of the pivoting mirror. This continuous calibration process is possible since the response of the mirror is so slow, that any glitches or artifacts would be so minor for most applications they should not be noticeable. In addition, when only a single image is generated for each sweep of the slow speed mirror, the appropriate adjustment could also occur during the reverse travel of the mirror (fly back portion) or drive signal (i.e. between points 20 and 14 of FIG. 1A) so long as position sensors (to be discussed hereinafter) are properly placed. Similarly, when used in a printer application, the adjustments or calibrations of the present invention could be carried out between the printing of pages.

However, to increase brightness, some embodiments of mirror display systems may also provide a second image during the linear portion of the slow speed mirror as it travels in the opposite direction. Of course, if images are produced in both the forward and reverse travel portion of the slow speed positioning mirror, there would not be a “fly back” blanked period for making adjustments or calibrations.

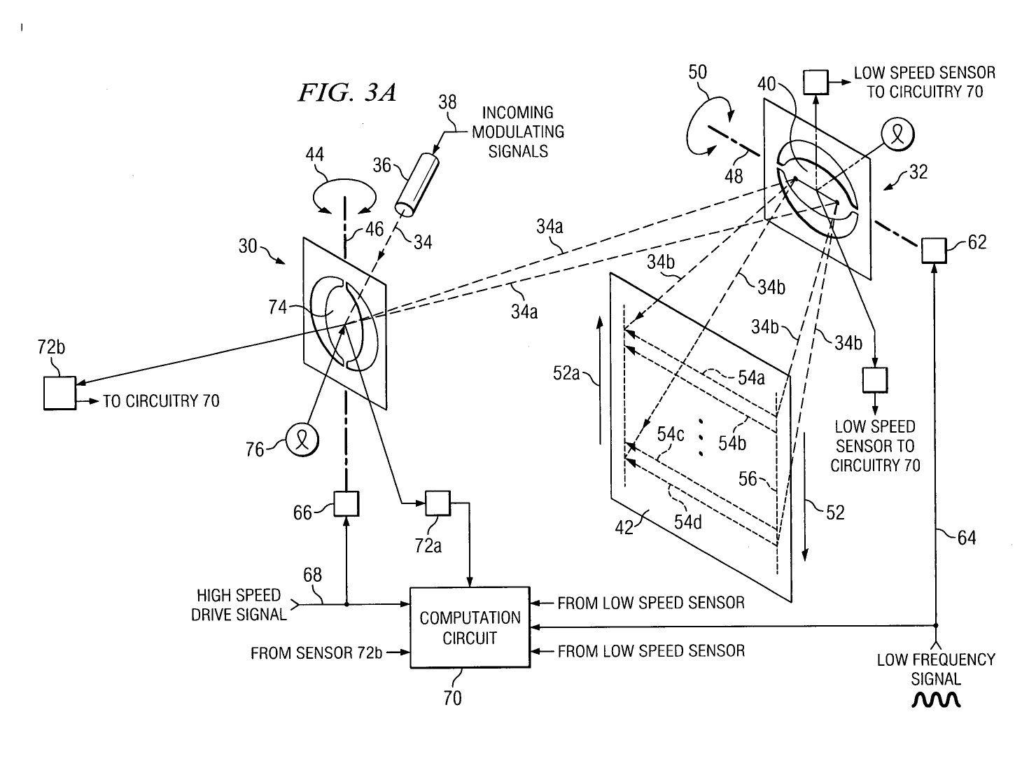

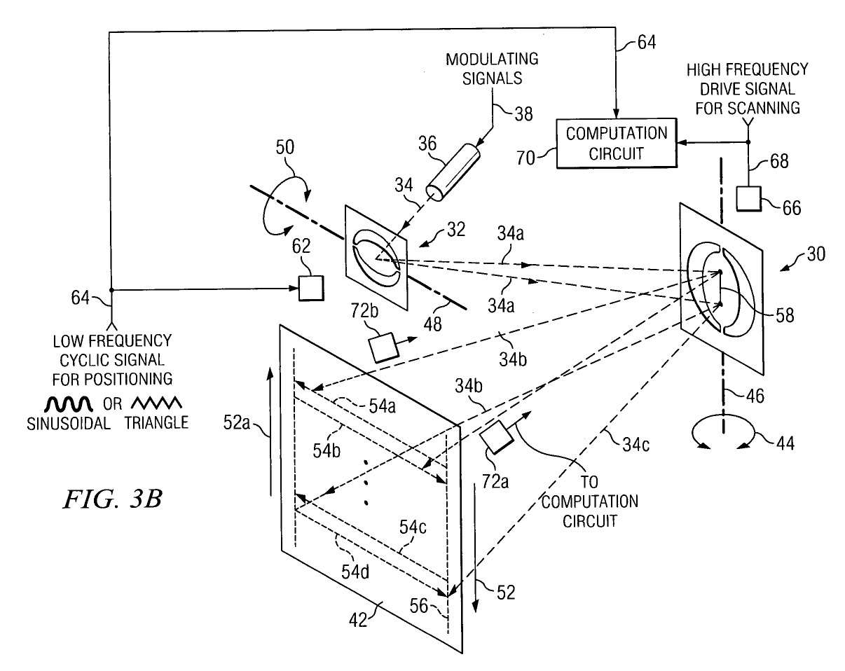

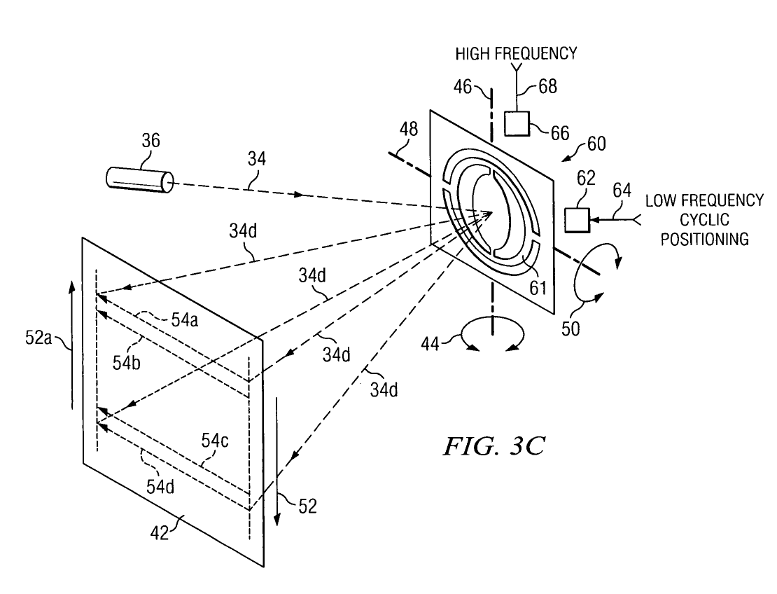

Referring now to FIG. 3A, there is a perspective illustration of an embodiment of the present invention that uses two single axis separate mirrors that pivot about their torsional hinges. As shown, a high frequency or scanning single axis torsional hinged mirror 30 may be used in combination with a low frequency or positioning single axis torsional hinged mirror 32 to provide a raster scan. A light beam 34 from a source 36 is modulated by incoming signals on line 38 to generate pixels that comprise the scan lines. The modulated light beam 34 impinges on the high frequency resonant mirror 30 and is reflected as sweeping light beam 34a to the reflecting surface 40 of the low frequency positioning mirror 32. Positioning mirror 32 redirects the modulated light beam 34b to a display surface 42, which may be a screen or light sensitive printer medium.

It will be appreciated by those skilled in the art, that a slow speed or orthogonally positioning mirror 32 is not normally used with mirror based printing. The movement orthogonal to the resonant scanning for spacing or positioning the image or scan lines is typically provided by movement of the photo sensitive medium, such as for example a rotating drum. Therefore, for printer applications, one single axis mirror is used. The laser and mirror arrangement would be similar to FIG. 3A except there would be no mirror 32. Instead, light from source 36 would impinge directly on the high speed resonant mirror 30, and be reflected directly to the display surface 42 which would typically be a photosensitive drum that rotates at a constant speed so that the print lines are evenly spaced.

The oscillations of the high frequency scanning mirror 30 (as indicated by arcuate arrow 44) around pivot axis 46 results in light beam 34b (the scan lines) sweeping across the surface 42, whereas the oscillation of the positioning mirror 32 about axis 48 (as indicated by double headed arrow 50) results in the scan lines being positioned vertically (or orthogonally to the scan lines) on the display surface 42. It is again noted that the terms horizontal and vertical are for explanation purposes only. Therefore, since the scanning motion of light beam 34b across display surface 42 may occur several hundred or even a thousand times during orthogonal movement in one direction of the low speed positioning mirror 32, as indicated by arrow 52, a raster scan type image can be generated or printed on display surface 42 as indicated by image lines 54a, 54b, 54c, and 54d. The light beam 34 often paints another image in the reverse direction as indicated by arrow 52a. That is, the second image is painted as the light beam returns to the starting point 56.

Referring to FIG. 3B, there is a perspective illustration of another embodiment of the present invention using two single axis separate mirrors that pivot about their torsional hinges. In this arrangement and contrary to the embodiment of FIG. 3A, the modulated beam is reflected from the positioning mirror 32 to the scanning mirror. This arrangement also illustrates a different placement of the sensors that will be discussed below. As shown, light beam 34 from source 36 is modulated by incoming video signals on line 38, as was discussed above, and impinges on the low frequency positioning mirror 32 rather than the high speed scanning mirror 30. The modulated light beam 34 is then reflected off of mirror 32 to the reflecting surface of the high frequency oscillation or scanning mirror 30. Mirror 30 redirects the modulated light beam 34b to display surface 42. The oscillations (as indicated by arcuate arrow 44) of the scanning mirror 30 about axis 46 still results in light beam 34b or the scan lines sweeping horizontally across display surface 42, whereas the oscillation of the positioning mirror 32 still results in the scan lines being positioned vertically on the display surface.

That is, oscillations of the positioning mirror 32 about axis 48, as indicated by double headed arcuate arrow 50, still move the reflected modulated light beam 34a with respect to scanning mirror 30 such that the light beam 34a moves orthogonally to the scanning motion of the light beam as indicated by line 58 in the middle of the reflecting surface of scanning mirror 30. Thus, it will be appreciated that in the same manner as discussed above with respect to FIG. 3A, the high frequency scanning motion of the light beam 34b as indicated by image lines 54a, 54b, 54c, and 54d on display screen 42 will still occur several hundred or even a thousand times during a single orthogonal movement of the low frequency positioning mirror 32. Therefore, as was the case with the embodiment of FIG. 3A, a raster scan type visual display can be generated or painted on display surface 42 in a single direction as indicated by arrow 52, or in both directions as indicated by arrow 52 and 52a.

The above discussion, with respect to FIGS. 3A and 3B, is based on two single axis torsional hinged mirrors. However, as will be appreciated by those skilled in the art, a single dual axis torsional hinged mirror, such as mirror structure 60 shown in FIG. 3C and which includes gimbals portion 61, may be used to provide both the high frequency scanning motion about axis 46a as indicated by arcuate arrow 44, and the positioning or orthogonal motion about axis 48, in the same manner as the oscillation of the individual mirrors 30 and 32 discussed in the embodiment of FIGS. 1A and 1B. The remaining elements of FIG. 3C operate the same as in FIGS. 3A and 3B and consequently carry the same reference number. It should also be noted, however, that the modulated light beam is only reflected one time and, therefore, the reflected beam carries reference number 34d.

As was discussed above, the embodiments of the present invention synchronize the incoming stream of video signals with the motion of the slow speed positioning mirror and the resonant mirror. As will be appreciated by those skilled in the art, the motion and corresponding position of the slow speed mirror can be determined and/or reasonably predicted or inferred from the signals used to drive the slow speed positioning mirror about its respective axis. For example, referring again to FIGS. 3A, 3B, and 3C as shown, there is a drive mechanism 62 for positioning the low speed mirror 32 in response to a low frequency cyclic signal such as illustrated in FIGS. 1A and 1B and which is received on input line 64.

Similarly, there is included a high speed drive mechanism 66 responsive to high frequency signals on input line 68 for driving the high speed mirror at its resonant frequency. There is also shown, computing circuitry 70 that receives the slow speed drive signals so that the position of the positioning or low speed mirror can be calculated. However, the drive signal for the high speed resonant mirror cannot be used to infer the position of the high speed mirror since there is a 180° phase shift in the transfer function of the resonant mirror in the neighborhood of the resonant frequency. Therefore, computing circuitry 70 also receives signals from position sensors (discussed hereinafter) representing the actual or monitored position of the high speed resonant mirror. It will be appreciated, of course, that other position sensors could be used to provide signals indicative of the actual position of the slow speed mirror.

The above discussion assumes that the high speed mirror is running at its resonant frequency such that the sweep amplitude substantially covers the display screen and produces an image with a proper amplitude and aspect ratio such as shown in FIG. 2A. However, as discussed, the resonant frequency of a high speed torsional hinged mirror may be affected by temperature change or mechanical stress that, in turn, stresses the high speed torsional hinges and changes the resonant frequency of the mirror.

Therefore, it is important that the sweep amplitude be maintained at substantially a constant level under such stress. However, if the sweep amplitude is to be maintained substantially at a constant level, it is necessary to know when changes start to appear in the amplitude. Therefore, referring again to FIGS. 3A and 3B, there is included at least one sensor such as sensor 72a for monitoring the actual position of the high sped resonant mirror.

In the embodiment of FIG. 3A, the sensor 72a is positioned to monitor the back side 74 of the high speed mirror 30 rather than the primary reflecting surface. Therefore, according to this embodiment, there is also included another light source 76 positioned so that at a known point in the travel path of the resonant mirror 30, light reflected from back side 74 of the resonant mirror will pass over or impinge upon sensor 72a. The single sensor 72a will preferably be located close to the end point of a travel sweep to produce a signal. It will be appreciated that another signal will also be generated by sensor 72a after the beam reverses direction and begins a new sweep in the opposite direction. Thus, if a signal or signals representing a known point or location in the travel path of the resonant mirror are provided by sensor 72a and the resonant frequency is known, the sweep amplitude can be calculated with reasonable accuracy. If even greater accuracy is desired, a second sensor 72b can be positioned close to the opposite end of the beam sweep. The use of two sensors will provide four intercept signals (two from each sensor), which allows increased accuracy in determining the parameter of the high speed beam sweep.

FIG. 3B illustrates an embodiment where the location of sensor 72a (and 72b) is located to monitor the reflection side of the scanning mirror 30. Therefore, in this embodiment, the sensors monitor the modulated beam sweep (rather than another light source 76 as used in the embodiment of FIG. 3A) to determine the position of the scanning mirror. It should be noted, however, that the arrangement of FIG. 3B cannot be used to adjust the sweep amplitude during the fly back portion of the low speed mirror even when an image is painted in only one direction since the modulated light beam 34 will not be on during the fly back period. However, for other suitable applications, the sensor 72a is located to be intercepted close to the end point of the beam sweep and provides an output when the beam sweep intercepts or passes the sensor 72a. As was discussed with respect to FIG. 3A, it will be appreciated that, according to the embodiment of FIG. 3B, the beam will also intercept the sensor 72a at one end of a sweep, and then again after the beam reverses direction and begins a new sweep in the opposite direction. Therefore, as discussed above, if signals are received proximate the end of a sweep and the beginning of the next sweep respectively, the sweep amplitude can be calculated with reasonable accuracy. Also, to determine the sweep amplitude with even greater accuracy, a second sensor, such as sensor 72b could also be positioned close to the other end point of the beam sweep.

Therefore, if it is determined that the sweep amplitude has decreased, according to the present invention, one of the parameters of the high speed drive signal that is received on line 68 and applied to the drive mechanism 66 is adjusted to maintain the beam sweep amplitude to the nominal value. One simple and direct way of doing this is to increase the amplitude or power of the drive signal to the necessary level to drive the beam sweep amplitude to the nominal or desired level. This approach works well for applications where the excess power required is readily available, and where power consummation is not an issue. It is also suitable for applications, which require a high bandwidth as well as tighter amplitude control.

However, as was discussed, if the drive signal frequency is very different from the resonant frequency of the mirror 30, the sweep amplitude change can be significant, and the increase in the drive signal power necessary to maintain the beam sweep amplitude may simply be too great for such a technique to be effective. Consequently, according to another embodiment, the frequency of the drive signal is changed to be the same or substantially the same as the new resonant frequency of the high speed mirror 30.

To accomplish this, according to an embodiment of this invention, the frequency of the drive signal is intentionally temporarily changed by a small selected or known amount in a first direction (i.e. increase the frequency of the drive signal or decrease the frequency) on a regular or periodic basis. To avoid noticeable changes in the image during this calibration, the change in frequency is preferably on the order of about 0.1 Hz. Sensors 72a and/or 72b, continually determine if the change in the drive signal frequency resulted in an increase or decrease in the sweep amplitude. If the sweep amplitude of the mirror increases, the frequency of the high speed drive signal is permanently reset as the new nominal or center drive frequency. Then during the next monitoring period, the frequency will again be adjusted in the same direction by the selected amount, and the sensors will again determine if the beam sweep amplitude increases or decreases. This process will repeat until the sensor determines that the beam sweep amplitude decreases with the frequency change. Then, the frequency of the drive signal is changed by the selected amount in the opposite direction and the sensors again determine if the beam sweep amplitude increases or decreases. It should also be noted that because of the high-Q of the mirror, the process of changing to a new central frequency may require several hundred cycles. Thus, it will be appreciated that according to this embodiment, the frequency of the drive signal is continually adjusted to be the same as the resonant frequency of the mirror. For more precise control of the beam sweep amplitude and to make the frequency changes less noticeable, the drive signal amplitude may also be changed (as was discussed above) along with change in the frequency of the drive signal. In addition, it will be appreciated that ideally the adjustments to the selected parameters of the high speed drive signal will occur during the upper and lower turn-around portion of the drive signal. However, as was discussed above, the high-Q of the mirror may not allow sufficient time for the adjustments during the upper and lower peak portions, which means the adjustments may be carried out continuously including the display period. For laser printer applications, the adjustment may occur between the printing of pages.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the system, methods and steps described in the specification. As one of ordinary skill in the art will readily appreciate from the disclosure of the present invention, system, processes, or steps, presently existing or later to be developed, that perform substantially the same function or achieve substantially the same result as the corresponding embodiments described herein may be utilized according to the present invention. Accordingly, the appended claims are intended to include within their scope such system, processes, methods, or steps.

What is claimed is:

1. In systems comprising a high-Q resonant mirror for generating scan lines a method of maintaining a constant amplitude of mirror oscillations comprising the steps of:
providing a high frequency signal for driving said high-Q resonant mirror with a selected amplitude and having a central frequency substantially at the resonant frequency of said mirror;
providing sensors to monitor the amplitude of said resonant mirror; and
adjusting a parameter of said high frequency drive signal to maintain the amplitude of said high-Q resonant mirror substantially at said selected amplitude.

2. The method of claim 1 wherein said step of adjusting the parameter of said high frequency drive signal comprises adjusting the amplitude of said high frequency drive signal.

3. The method of claim 1 wherein said high frequency drive signal is a sinusoidal signal.

4. The method of claim 1 wherein said step of adjusting the parameter of said high frequency drive signal comprises adjusting the frequency of said high frequency signal.

5. The method of claim 4 further comprising adjusting the amplitude of said high frequency signal at the same time the frequency of said high frequency signal is being adjusted.

6. The method of claim 3 further comprising a low frequency mirror for positioning said scan lines.

7. The method of claim 6 wherein said low frequency mirror is driven by the sinusoidal signal.

8. The method of claim 6 wherein said signal driving said high frequency mirror is about a 20 kHz signal and said signal driving said low frequency mirror is about a 60 Hz signal.

9. The method of claim 1 wherein said step of maintaining the amplitude of said high frequency mirror constant comprises the steps of:
temporarily changing the frequency of said high frequency drive signal by a selected amount in a first direction to a new selected frequency;
monitoring the amplitude change of said high speed mirror drive due to said temporary frequency change in said first direction;
if said amplitude of said mirror increases, adjust the central frequency of said high speed drive signal to said new selected frequency; and
if said amplitude of said mirror decreases, temporarily change the frequency of said high speed mirror by said selected amount in the opposite direction and repeat said step of monitoring the amplitude change and adjusting the frequency.

10. The method of claim 1 wherein said system is a laser printer.

11. The method of claim 1 wherein said system is a visual display.

12. The method of claim 1 wherein said step of adjusting is continuous.

13. The method of claim 7 wherein said low frequency drive signals define peak portions and display portions, and said step of adjusting occurs during said peak portions.

14. The method of claim 13 wherein said step of adjusting occurs during both said peak portions and said display portion.

15. The method of claim 7 wherein said low frequency drive signals define peak portions and forward moving and reverse moving display portions.

16. The method of claim 15 wherein said scan lines are generated in both said forward and reverse moving display portions.

17. The method of claim 15 wherein said scan lines are generated in only one of said forward and reverse moving display portions, and said step of adjusting occurs during the other one of said forward and reverse moving display portions.

18. The method of claim 1 wherein said high-Q resonant mirror is further supported by a gimbals portion and a second set of torsional hinges and wherein movement about said second set of torsional hinges positions said scan line on a display surface orthogonally to the sweep of said scan lines.

19. The method of claim 10 wherein said step of adjustment occurs between pages being printed.

20. The method of claim 6 wherein said low frequency mirror reflects light toward said scanning mirror.

21. The method of claim 6 wherein said high frequency resonant mirror reflects light toward said slow speed positioning mirror.
